(19) United States
(12) Patent Application Publication
(10) Pub. No.: US 2006/0212677 A1
(43) Pub. Date: Sep. 21, 2006

(54) Multicore processor having active and inactive execution cores

(75) Inventor: Tryggve Fossum, Northborough, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/081,306

(22) Filed: Mar. 15, 2005

(51) Int. Cl. G06F 15/00

(52) U.S. Cl. 712/1

(57) ABSTRACT

Embodiments of a multicore processor having active and inactive execution cores are disclosed. In one embodiment, an apparatus includes a processor having a plurality of execution cores on a single integrated circuit, and a plurality of core identification registers. Each of the plurality of core identification registers corresponds to one of the execution cores to identify whether the execution core is active.

### BACKGROUND

1. Field

The present disclosure pertains to the field of data processing, and more particularly, to the field of redundancy in data processing apparatuses.

2. Description of Related Art

Generally, redundancy in data processing apparatuses has been used to improve fault tolerance, reliability, and manufacturing yield. Computers have been built with redundant elements, such as data storage disks, to prevent the loss of data in the event of a hardware failure. Computers have also been built with redundant elements, such as processor chips, to provide for automatic replacement of an element that fails during use, or to provide for error detection by executing instructions in “lockstep,” meaning that instructions are executed redundantly. Computer chips including circuitry that may be arranged as arrays, such as memories, have been built with redundant columns that may be used to replace columns that include manufacturing defects or fail as a result of use. However, the use of redundancy within processor chips has been limited by the dense, irregular nature of the transistor layout in processors.

### BRIEF DESCRIPTION OF THE FIGURES

The present invention is illustrated by way of example and not limitation in the accompanying figures.

FIG. 1 illustrates a multicore processor having active and inactive execution cores according to an embodiment of the present invention.

FIG. 2 illustrates a method including reconfiguring a multicore processor to activate a spare core according to an embodiment of the present invention.

FIG. 3 illustrates a system including a multicore processor having active and inactive execution cores according to an embodiment of the present invention.

### DETAILED DESCRIPTION

The following description describes embodiments of data processing apparatuses, methods, and systems in which multicore processors have active and inactive execution cores. In the following description, numerous specific details, such as component and system configurations, may be set forth in order to provide a more thorough understanding of the present invention. It will be appreciated, however, by one skilled in the art, that the invention may be practiced without such specific details. Additionally, some well known structures, circuits, techniques, and the like have not been described in detail, to avoid unnecessarily obscuring the present invention.

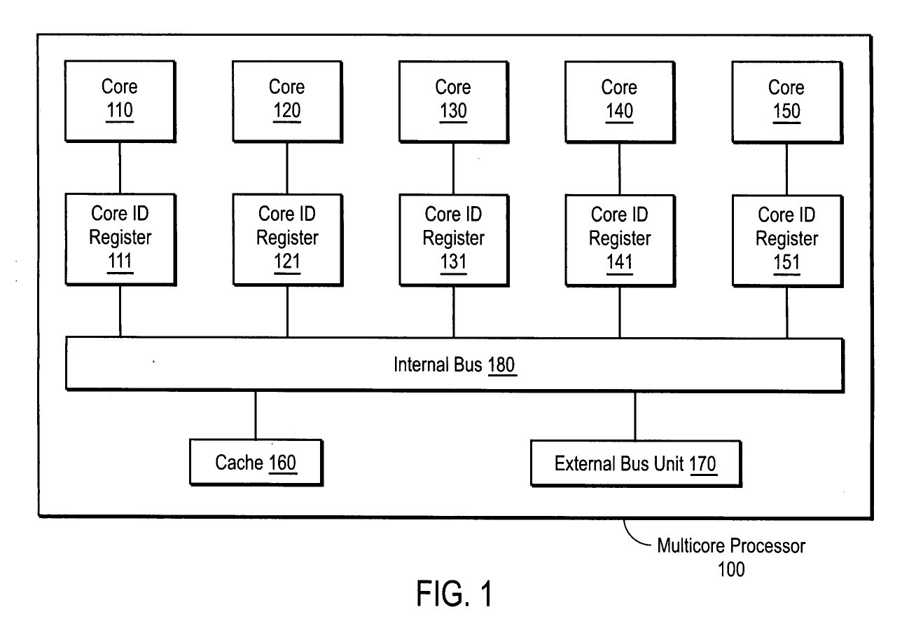

FIG. 1 illustrates multicore processor 100 according to an embodiment of the present invention. Generally, a multicore processor is a single integrated circuit including more than one execution core. An execution core includes logic for executing instructions. In addition to the execution cores, a multicore processor may include any combination of dedicated or shared resources within the scope of the present invention. A dedicated resource may be a resource dedicated to a single core, such as a dedicated level one cache, or may be a resource dedicated to any subset of the cores. A shared resource may be a resource shared by all of the cores, such as a shared level two cache or a shared external bus unit supporting an interface between the multicore processor and another component, or may be a resource shared by any subset of the cores.

Multicore processor 100 has five execution cores 110, 120, 130, 140, and 150, and five core identification registers 111, 121, 131, 141, and 151. Multicore processor 100 also includes cache 160 and external bus unit 170 to be shared by cores 110, 120, 130, 140 and 150 through internal bus 180.

Execution cores 110, 120, 130, 140, and 150 are designed to be identical. Each is independently capable of executing instructions compatible with multicore processor 100. However, in this embodiment, multicore processor 100 is designed for a system environment with only three execution cores. Two of the five execution cores in multicore processor 100 are provided in a desire to improve fault tolerance, reliability, manufacturing yield, or other parameter, as will be described below. Therefore, core identification registers 111, 121, 131, 141, and 151 may identify which of cores 110, 120, 130, 140, and 150 are active.

For example, in an embodiment where the three execution cores expected in the system environment to be provided in multicore processor 100 are identifiable by the rest of the chip, other hardware, and software as execution cores with addresses of “0,” “1,” and “2,” a core address of “0” may be stored in core identification register 111, a core address of “1” may be stored in core identification register 121, and a core address of “2” may be stored in core identification register 141. Therefore, in this case, core identification register 111 identifies core 110 as active, core identification register 121 identifies core 120 as active, and core identification register 141 identifies core 140 as active. Core identification registers 111, 121, 131, 141, and 151 may be programmable, so that each of core address “0,” core address “1,” and core address “2” may be stored in any of the core identification registers. In this way, each and any of the five cores of multicore processor 100 may be identified as an active core. Those that are not active may be, by default, identified as inactive, or, alternatively, may be identified as inactive by a “dummy” value in the corresponding core identification register.

As another example, in an embodiment where software, such as an operating system (“OS”) or a virtual machine monitor (“VMM”), designed to run on a system using multicore processor 100 may be capable of scheduling programs or instructions to run on, or accessing machine or model specific registers (“MSRs”) within, a specific core with an instruction or command that includes a parameter, operand, or address identifying the core. In that case, information corresponding to that parameter or operand may be stored in the core identification register of a specific core, thereby identifying that core as active. In an alternative embodiment, there may be a layer of firmware or other code stored in a non-volatile memory, such as microcode or a processor abstraction layer (“PAL”), between the software and the execution cores, which may translate or map the parameter, operand, or address identifying the core to another parameter, operand, or address that corresponds to information stored in the core identification register of an active core. In yet another alternative embodiment, software may not be capable of scheduling or accessing a specific core, and instead, a PAL may perform scheduling, configuration, and other accessing of specific cores by addressing the active cores based on the contents of their core identification registers.

In other embodiments, there may be any combination of sharing or division of accessibility to specific cores by software, a PAL, or other firmware. For example, particular bits in an MSR may identify a core to an operating system or a PAL, but a PAL may map or translate an MSR address to a different core by writing or reading a programmable configuration register. In the embodiment of FIG. 1, the contents of an MSR in core 130 may identify core 130 as core 130 based on its position on the die, and the contents of an MSR in core 140 may likewise identify core 140 as core 140. However, a PAL may program a configuration register, in this case core identification register 131, to remap accesses to core address 130 to core 140, such that a subsequent instruction addressing core 130 is translated by the PAL to access core 140 instead of core 130. In this way, core 130 is identified as an inactive core and core 140 is identified as an active core.

In each of the foregoing embodiments, an active core is a core that is, at a particular time, executing or available to execute instructions, and an inactive, or spare, or redundant, core is a core that is, at a particular time, not executing and not available to execute instructions. An active core is distinguishable from an inactive core, or made available to execute instructions, based on the contents of a corresponding core identification register.

In the embodiment of FIG. 1, core identification registers 111, 121, 131, 141, and 151 are programmable. Therefore, a PAL or other firmware may reconfigure multicore processor 100 by changing the contents of one or more of the core identification registers. This reconfiguration may be done at any time within the scope of the present invention, i.e., before or after multicore processor 100 is sold or built into a system. If the reconfiguration involves an active core upon which a program or process is running, the PAL may emulate a context switch from the old active core to the new active core, or the PAL may call on the OS to perform a context switch from the old active core to the new active core.

The capability of reconfiguring an execution core from inactive to active, and vice versa, in multicore processor 100 may provide a number of advantages that may be achieved alone or in combination, and make multicore processor 100 desirable for a number of applications.

First, a manufacturer of multicore processor 100 may test each core for manufacturing defects, and improve manufacturing yield by configuring any that are defective as inactive. A non-volatile memory, such as an on-package flash memory, accessible to the PAL, may be used to store status bits indicating whether any of the cores are non-functional. The non-volatile memory may or may not also include the PAL within the scope of the present invention. This advantage becomes more valuable as transistor count per die increases and allows more cores, cache, and other resources to be placed on a single die. The relative cost of adding inactive cores will decrease and may be used to offset potential reductions in manufacturing yield from increased transistor density and die size.

Second, the reliability, availability, and serviceability of a system built with multicore processor 100 may be improved by providing for the automatic replacement of an active core that fails in the field with a functional inactive core. This replacement may be made transparent to the user by using the PAL or other firmware to automatically test for, or receive reports of, a core failure, or high error rates that may be indicative of a pending core failure, and automatically reconfigure multicore processor 100 if a failure is detected or predicted. This advantage may be leveraged by a manufacturer of multicore processor 100 to reduce the time, temperature, voltage, or other stress of a “burn-in” operation that the manufacturer performs to reduce infant mortality. Such as reduction in burn-in may be valuable as transistor dimensions and operating voltages decrease to the point where the burn-in operation may otherwise significantly reduce lifetime in the field.

Third, a vendor of multicore processor 100 may create a product line from a single part by activating a different number of cores for different applications. For example, a product line may include a high priced, high performance version of multicore processor 100, with three active cores, and a low priced, low performance version, with one active core.

Fourth, systems built with multicore processor 100 may support “capacity on demand” by letting the user dynamically choose the number of cores to be activated. For example, a customer's purchase of an additional core may be supported by transmitting an encrypted PAL configuration file to the system.

Fifth, PAL code for multicore processor 110 may configure two cores to run in lockstep according to any known technique. Having an inactive core available to run critical sections of code in lockstep selectively may provide increased fault tolerance with a lower impact on power and performance than may be provided by continuously running code in lockstep.

Sixth, when multicore processor 100 is used in a server system, an inactive core may be activated as a service processor for service management, to monitor the operation of the system, deal with booting, initialization, testing, errors, reconfiguration, system partitioning, and allocating of resources between users. Using one of the spare cores in multicore processor 100 may provide greater visibility into the operation of the active cores and other resources in multicore processor 100 than may be provided by using an additional processor on a separate chip.

These advantages and applications, or any other advantages, applications, or factors may be considered to choose the number of active cores and inactive cores in an embodiment of the invention. Although the embodiment of FIG. 1 includes three active cores and two inactive cores, any number of cores, any number of active cores, and any number of inactive cores are possible within the scope of the present invention. For example, another embodiment may include eight active cores and one inactive core.

Furthermore, embodiments of the present invention may include known techniques related to redundant, inactive, or selectively or dynamically active circuitry or features. For example, in some embodiments, known power management techniques may be used to gate off the clocks or power to inactive cores.

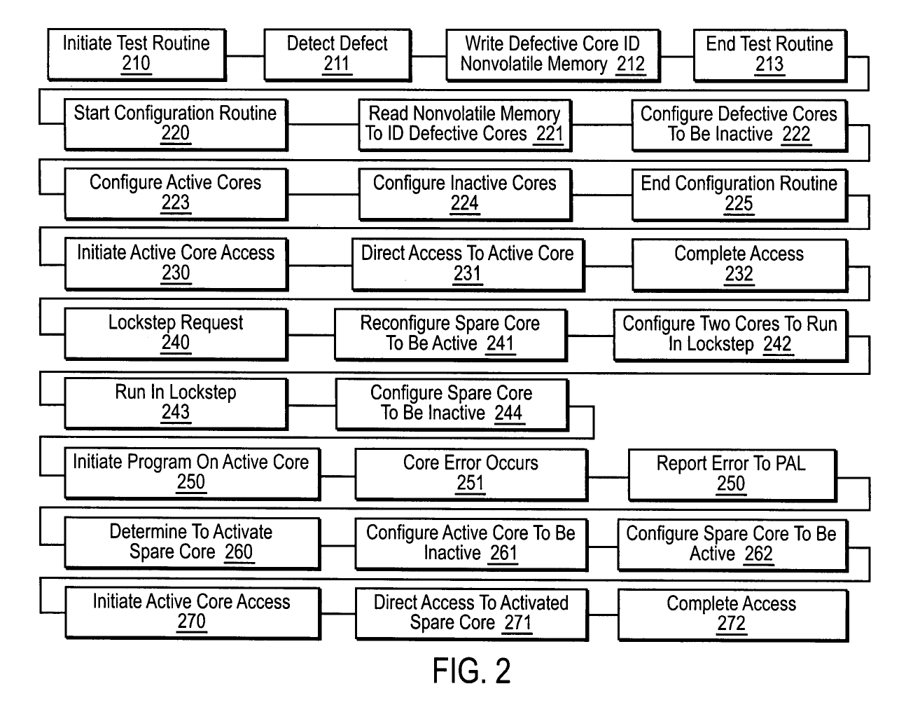

FIG. 2 illustrates a method including reconfiguring a multicore processor to activate a spare core according to an embodiment of the present invention. In block 210, a test routine to test the functionality of execution cores of a multicore processor is initiated. The test routine may be loaded or run from a tester memory, a non-volatile memory such as a PAL or microcode, or any other memory within or accessible to the multicore processor. In block 211, a defect is detected in a first execution core. In block 212, a value is written to a non-volatile memory to indicate that the first execution core is defective. In block 213, the test routine is ended.

In block 220, a configuration routine is started to configure the active and inactive execution cores of a multicore processor. The configuration routine may be a routine in a PAL, an OS, or any other firmware or software compatible with the multicore processor. In block 221, the non-volatile memory is read to determine that the first core is defective. In block 222, the first execution core is configured to be inactive. Block 222 may be performed, for example, by writing a value corresponding to an address of an inactive core to a first core identification register. In block 223, a second execution core is configured to be active. Block 223 may be performed, for example, by writing a value corresponding to an address of an active core to a second core identification register. In block 224, a third execution core is configured to be inactive. Block 224 may be performed, for example, by writing a value corresponding to an address of an inactive core to a third core identification register. In block 225, the configuration routine is ended.

In block 230, an access is initiated to an active core of the multicore processor. The access may be the scheduling of a program or process, the read or write of an MSR, or any other type of access that may be performed by an OS, a VMM, a PAL, or any other software or firmware. In block 231, the access is directed to the second core. Block 231 may be performed, for example, by addressing the second core according to the contents of the second core identification register. In block 232, the access is completed, for example, by executing a program scheduled for the second core on the second core.

In block 240, an OS, VMM, PAL, or other software or firmware requests or determines that instructions to be executed on the multicore processor are to be run in lockstep. In block 241, the third execution core is configured to be active. Block 241 may be performed, for example, by PAL or other firmware writing a value corresponding to an address of an active core to the third core identification register. In block 242, the multicore processor is configured to run the second and the third execution cores in lockstep. In block 243, the instructions are run in lockstep on the second and third execution cores. In block 244, the third execution core is configured to be inactive. Block 244 may be performed, for example, by PAL or other firmware writing a value corresponding to an address of an inactive core to the third core identification register.

In block 250, a program or process is initiated on the second core. The program or process may be any program or process designed to run on the multicore processor, including a PAL test routine to test the functionality of a core. In block 251, an error occurs in the program or process. In block 252, the error is reported to a PAL or other firmware.

In block 260, a PAL or other firmware determines that the third core is to be activated. The determination may be based on the PAL receiving a report of an error on the second core as in block 252, the PAL monitoring the rate of reports of errors on the second core, the PAL determining that the number of transient errors on the second core has exceeded a predetermined threshold, the PAL otherwise detecting an error or error rate exceeding a threshold on the second core, any hardware, firmware, software, or user determining that the second core or any active core is to be deactivated, any hardware, firmware, software, or user determining that an additional core is to be activated, or any other factor. In block 261, any program, process, or instruction stream running on the second execution core is halted, the state of the second execution core is extracted and saved to memory, and the second execution core is configured to be inactive. Block 261 may include, for example, by PAL or other firmware writing a value corresponding to an address of an inactive core to the second core identification register, and may also include storing an indication that the second execution core is defective in a non-volatile memory. In block 262, the third execution core is configured to be active. Block 262 may include, for example, by PAL or other firmware writing a value corresponding to an address of an active core to the third core identification register. For example, the value written to the third core identification register in block 262 may be the same as the value written to the second core identification register in block 223. In other words, or in any other manner, the third execution core may be given the identity formerly associated with the second execution core. Alternatively, the value written to the third execution core identification register may be any other value otherwise associated with an address of the second core, or any other value associated with an active core. Block 262 may also include loading the state saved from the second execution core into the third execution core.

In block 270, an access is initiated to an active core of the multicore processor. The access may be the scheduling of a program or process, the read or write of an MSR, or any other type of access that may be performed by an OS, a VMM, a PAL, or any other software or firmware. In particular, the access may be identical to the access of block 230, such as an OS scheduling a program for execution on the same core that was scheduled in block 230, a PAL access to the same MSR that was accessed in block 230, or any other access to the same core as in block 230. Alternatively, the access may not include any reference to an identity of a specific core. In block 271, the access is directed to the third core. Block 271 may be performed, for example, by addressing the third core according to the contents of the third core identification register. Alternatively or in conjunction, block 271 may be performed by a PAL or other firmware reading the contents of the second core identification register, determining that the second core is inactive, translating an address associated with the access from the second core to the third core, remapping the access to the third core, or any combination of these actions. In block 272, the access is completed, for example, by executing a program scheduled for the second core on the third core.

Within the scope of the present invention, the method illustrated in FIG. 2 may be performed in a different order, with illustrated steps omitted, with additional steps added, or with a combination of reordered, omitted, or additional steps.

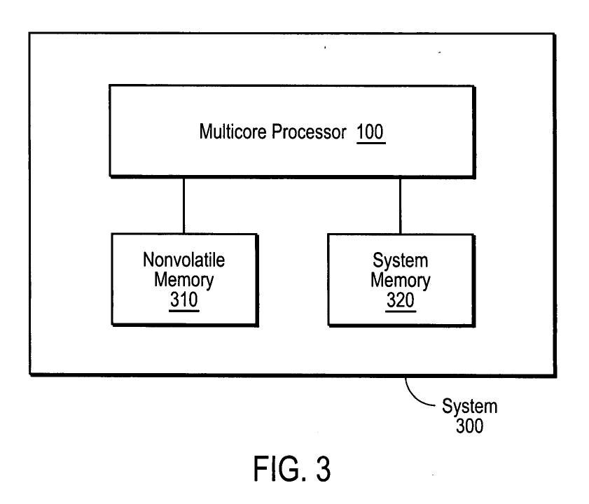

FIG. 3 illustrates a system 300 including multicore processor 100 having active and inactive cores according to an embodiment of the present invention. System 300 also includes non-volatile memory 310 and system memory 320, which may be coupled to multicore processor 100 directly, through a bus or busses, through any other components, such as a memory controller or system logic, or through any combination of direct connections, busses, or other components.

Non-volatile memory 310 may be any type of non-volatile or persistent memory, such as semiconductor-based programmable read only memory or flash memory. Non-volatile memory 310 may be used to store a PAL, status registers to indicate if execution cores are defective, and any other instructions or information that is to be retained while system 300 is not powered on.

System memory 320 may be any type of memory, such as static or dynamic random access memory or magnetic or optical disk memory. System memory 320 may be used to store instructions to be executed by and data to be operated on by multicore processor 100, or any such information in any form, such as operating system software, application software, or user data.

System 300 may also include any other buses, such as a peripheral bus, or components, such as input/output devices, in addition to processor 100, non-volatile memory 310 and system memory 320.

Processor 100, or any other component or portion of a component designed according to an embodiment of the present invention may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these media may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the acts of a communication provider or a network provider may be acts of making copies of an article, e.g., a carrier wave, embodying techniques of the present invention.

Thus, a multicore processor having active and inactive execution cores has been disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
a processor having a plurality of execution cores on a single integrated circuit; and
a plurality of core identification registers, each core identification register corresponding to one of the plurality of execution cores to identify whether the corresponding one of the plurality of execution cores is active.

2. The apparatus of claim 1, wherein the plurality of execution cores is a plurality of identical execution cores.

3. The apparatus of claim 1, wherein one of the plurality of execution cores is configured to be inactive.

4. The apparatus of claim 3, further comprising a non-volatile memory to store instructions that, when executed by the processor, reconfigure the one of the plurality of execution cores to be active.

5. The apparatus of claim 1, wherein a first one of the plurality of core identification registers is programmable to change a first one of the plurality of execution cores from inactive to active.

6. The apparatus of claim 5, wherein a second one of the plurality of core identification registers is programmable to change a second one of the plurality of execution cores from active to inactive.

7. A method comprising:
determining that a spare core of a multicore processor is to be activated; and
configuring the multicore processor to activate the spare core.

8. The method of claim 7, wherein determining that the spare core is to be activated includes determining that an active core of the multicore processor is to be replaced.

9. The method of claim 8, further comprising configuring the multicore processor to deactivate the active core.

10. The method of claim 9, further comprising labeling the active core as defective.

11. The method of claim 9, further comprising saving state of the active core.

12. The method of claim 11, further comprising loading state of the active core into the spare core.

13. The method of claim 7, wherein determining that a spare core is to be activated includes determining that an active core of the multicore processor is to execute in lockstep with the spare core.

14. The method of claim 13, wherein configuring the multicore processor to activate the spare core includes configuring the active core and the spare core to execute in lockstep.

15. The method of claim 7, wherein configuring the multicore processor to activate the spare core includes modifying the contents of a core identification register corresponding to the spare core.

16. A method comprising:
scheduling a first program for execution on a first core of a multicore processor;
executing the first program on the first core;
reconfiguring the multicore processor to map an identification of the first core to a second core;
scheduling a second program for execution on the first core; and
executing the second program on the second core.

17. The method of claim 16, wherein reconfiguring the multicore processor to map an identification of the first core to a second core includes changing the contents of a core identification register corresponding to the second core.

18. The method of claim 16, further comprising determining that the first core is to be replaced.

19. The method of claim 18, wherein determining that the first core is to be replaced includes detecting an error in the execution of the first program.

20. A system comprising:
a dynamic random access memory;
a processor having a plurality of execution cores on a single integrated circuit; and
a plurality of core identification registers, each corresponding to one of the plurality of execution cores to identify whether the corresponding one of the plurality of execution cores is active.
